(19) United States
(12) Patent Application Publication
(10) Pub. No.: US 2016/0050587 A1
(43) Pub. Date: Feb. 18, 2016

(54) PROACTIVE NETWORK CONGESTION MITIGATION

(71) Applicant: Verizon Patent and Licensing Inc., Arlington, VA (US)

(72) Inventors: Maria G. Lam, Oakland, CA (US); Lalit R. Kotecha, San Ramon, CA (US); Priscilla Lau, Fremont, CA (US); John F. Macias, Antelope, CA (US); Mingxing S. Li, San Jose, CA (US); David Chiang, Fremont, CA (US)

(21) Appl. No.: 14/461,121

(22) Filed: Aug. 15, 2014

(51) Int. Cl. H04W 28/08; H04W 28/02; H04W 36/22

(52) U.S. Cl. CPC H04W 28/08; H04W 36/22; H04W 28/0289; H04W 84/12

(57) ABSTRACT

A device may proactively mitigate network congestion and reduce network load on a network device. In some implementations, the device may monitor load information associated with a base station in communication with a user device via a wireless cellular network; determine, based on the load information, that load on the base station should be reduced; determine, in response to the determination that the load on the base station should be reduced, and based on a type of traffic being transmitted to the user device via the base station, whether traffic for the user device can be offloaded to an access point within communications range of the user device; and cause, based on determining that the traffic for the user device can be offloaded to the access point, the user device to communicate via the access point and discontinue transmitting the traffic via the base station.

### BACKGROUND

User devices may access a network, via different frequency bands, radio protocols, and/or network devices. When a relatively large quantity of user devices are located in a particular area (e.g., in the case of a popular event at a public venue), a network device (e.g., a base station associated with a cellular network), may become congested. For example, interference of a frequency band, associated with the base station, may increase as the quantity of user devices connected to the base station increases. Similarly, processing with the base station, may become overloaded.

### BRIEF DESCRIPTION OF THE DRAWINGS

FIG. 1 illustrates an example overview of an implementation described herein;

FIG. 2 illustrates an example environment in which systems and/or methods, described herein, may be implemented;

FIG. 3 illustrates a load balancing server communicating with multiple base stations, mobility and management entities, and access points;

FIG. 4 illustrates a flowchart of an example process for mitigating network congestion associated with a particular base station;

FIGS. 5-6 illustrate an example implementation for proactively handing off user devices from a first base station to a second base station;

FIG. 7 illustrates an example implementation for proactively mitigating load on a base station based on event information;

FIGS. 8 and 9 illustrate an example implementation for proactively mitigating load on a base station by transferring communications to an access point;

FIG. 10 illustrates an example implementation for proactively mitigating load on a base station by modifying network transmission policies;

FIG. 11 is a flow chart of an example process for generating and outputting a load indicator; and

FIG. 12 illustrates example components of one or more devices, according to one or more implementations described herein.

### DETAILED DESCRIPTION OF THE PREFERRED EMBODIMENTS

The following detailed description refers to the accompanying drawings. The same reference numbers in different drawings may identify the same or similar elements.

A user device may communicate with a base station in order to access a cellular network. The base station may become overloaded or congested when a relatively large quantity of user devices are located in a communications range of the base station. In existing systems, when experiencing network congestion, a user device may reactively attempt to communicate with a different base station, communicate via a different radio, and/or communicate via different frequency bands (e.g., base stations, radios, and/or frequency bands having less congestion). As such, the user device may reactively attempt to mitigate network congestion after experiencing symptoms of the network congestion (e.g., increased latency, reduced transfer speeds, etc.).

Systems and/or methods, as described herein, may monitor load information, associated with network devices, and proactively mitigate network congestion based on the load information. For example, network congestion may be proactively mitigated based on information identifying a quantity of established sessions associated with a network device, a quantity of established sessions associated with a particular radio of the network device, a measure of interference of a frequency band associated with the network device, and/or some other measure of load. In some implementations, network congestion may be proactively mitigated by transferring communications of a user device from one network device to another network device, one radio type to another radio type (e.g., from a long-term evolution (LTE) radio type to a Wi-Fi radio type), or one frequency band to another frequency band. As a result of the proactive mitigation, a user of a user device may experience fewer symptoms of network congestion (e.g., increased latency, reduced audio/video quality, etc.) in relation to when network congestion is reactively mitigated.

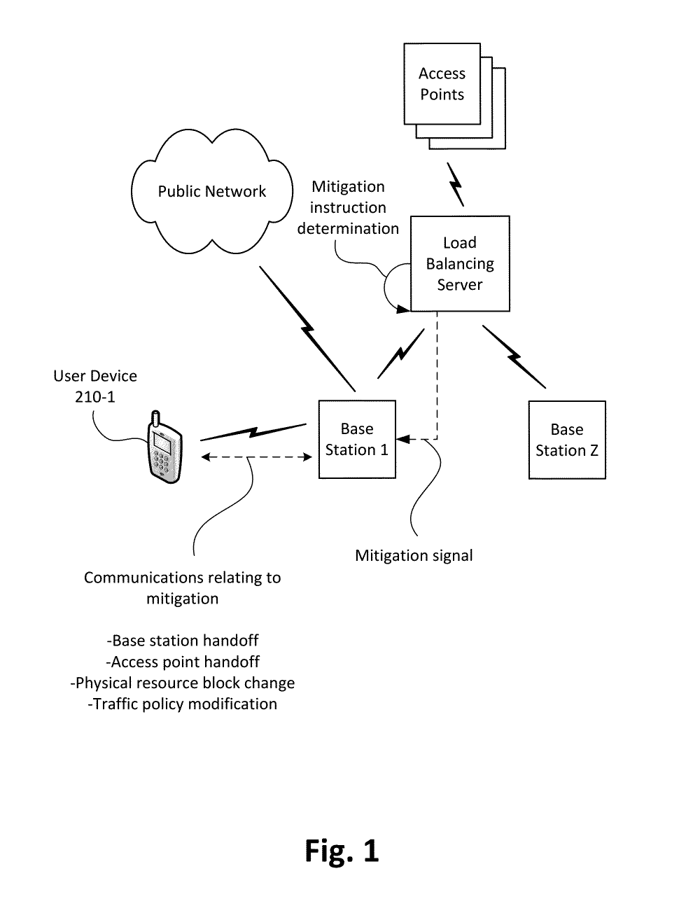

FIG. 1 illustrates an example overview of an implementation described herein. As shown in FIG. 1, a load balancing server may communicate with multiple base stations (e.g., base station 1 through base station Z, where Z is an integer greater than or equal to 1). The base station may be associated with a cellular network and may provide access to a public network. During the communications, the load balancing server may determine load information associated with the resource blocks of the base stations. For example, resource blocks may relate to a quantity of sessions established with the base stations, interference information of one or more frequency bands associated with the base stations, interference and/or load of radios via which the base station communicate, etc. The load balancing server may also determine load information associated with one or more access points (e.g., network devices that may provide access to the public network independently of the cellular network). The load balancing server may also monitor communications of a user device connected to base station 1.

Based on the load information, the load balancing server may determine that a level of load or congestion, associated with base station 1, has exceeded a threshold. The load balancing server may determine a mitigation instruction that, when executed, may reduce the load on base station 1 and/or the load on the resource blocks associated with base station 1. For example, the load balancing server may determine a mitigation instruction to cause the user device to transfer communications from base station 1 to another base station. Additionally, or alternatively, the load balancing server may determine a mitigation instruction to cause the user device to transfer communications from base station 1 to an access point (e.g., when the communications, associated with the user device, do not require a communication with the base station). Additionally, or alternatively, the load balancing server may determine a policy to apply for traffic transmitted to and/or from the user device. Additionally, or alternatively, the load balancing server may determine some other instruction that may mitigate the load on base station 1, thereby reducing the load on base station 1 and improving network performance.

As further shown in FIG. 1, the load balancing server may output the mitigation signal to base station 1. In some implementations, base station 1 may communicate with the user device in order to execute the mitigation instruction. For example, base station 1 may facilitate a handoff of the user device to another base station. Additionally, or alternatively, base station 1 may cause the user device to communicate via a different radio or via a different frequency band (either a different radio or different frequency band of base station 1 or a different radio or frequency band of another base station). Additionally, or alternatively, base station 1 may cause the user device to communicate with an access point (e.g., an access point of a Wi-Fi access network) in lieu of base station 1. Additionally, or alternatively, base station 1 may implement policies that may reduce the load on base station 1. As such, the load balancing server may proactively mitigate overloaded network devices, frequency bands, radios, etc., based on real-time load information, thereby improving network performance. In some implementations, the load balancing server may proactively mitigate overloaded network devices, frequency bands, radios, etc., based on event information and/or some other information that may be used to anticipate that network resources may become overloaded. As a result of the proactive mitigation, a user of a user device may experience fewer symptoms of network congestion (e.g., increased latency, reduced audio/video quality, etc.) in relation to when network congestion is reactively mitigated.

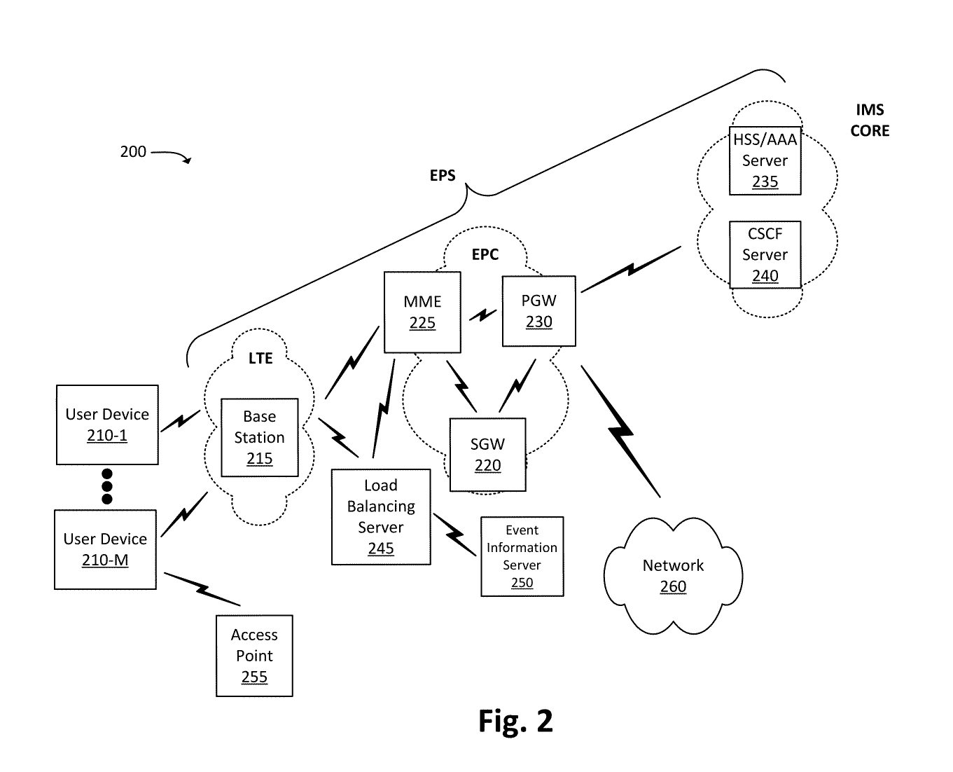

FIG. 2 is a diagram of an example environment 200 in which systems and/or methods described herein may be implemented. As shown in FIG. 2, environment 200 may include user devices 210, . . . , 210-M (where M≧1), a base station 215, a serving gateway 220 (referred to as “SGW 220”), a mobility management entity device 225 (referred to as “MME 225”), a packet data network (PDN) gateway (PGW) 230 (referred to as “PGW 230”), a home subscriber server (HSS)/authentication, authorization, accounting (AAA) server 235 (referred to as an “HSS/AAA server 235”), a call service control function (CSCF) server 240 (referred to as “CSCF server 240”), load balancing server 245, event information server 250, access point 255, and a network 260.

Environment 200 may include an evolved packet system (EPS) that includes a long term evolution (LTE) network, an evolved packet core (EPC), and/or an Internet protocol (IP) multimedia subsystem (IMS) core that operate based on a third generation partnership project (3GPP) wireless communication standard. The LTE network may be a radio access network (RAN) that includes one or more base stations, such as eNodeBs (eNBs), via which user device 210 communicates with the EPC. The EPC may include SGW 220, MME 225, and/or PGW 230 and may enable user device 210 to communicate with network 280 and/or the IMS core. The IMS core may include HSS/AAA server 235 and/or CSCF server 240. The IMS core may manage authentication, connection initiation, account information, a user profile, etc. associated with user device 210. As shown in FIG. 2, the LTE network may include base station 215, and the EPC may include SGW 220, MME 225, and/or PGW 230.

User device 210 may include a computation or communication device, such as a wireless mobile communication device that is capable of communicating with base station 215 and/or a network (e.g., network 260). For example, user device 210 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a laptop computer, a tablet computer, a camera, a personal gaming system, or another type of computation or communication device. User device 210 may send data to and/or receive data from network 260.

Base station 215 may include one or more network devices that receive, process, and/or transmit traffic, such as audio, video, text, and/or other data, destined for and/or received from user device 210. In an example implementation, base station 215 may be an eNB device and may be part of the LTE network. Base station 215 may receive traffic from and/or send traffic to network 280 via SGW 220 and PGW 230. Base station 215 may send traffic to and/or receive traffic from user device 210 via an air interface. One or more of base stations 220 may be associated with a RAN, such as the LTE network.

SGW 220 may include one or more network devices, such as a gateway, a router, a modem, a switch, a firewall, a network interface card (NIC), a hub, a bridge, a proxy server, an optical add-drop multiplexer (OADM), or some other type of device that processes and/or transfers traffic. SGW 220 may, for example, aggregate traffic received from one or more base stations 220 and may send the aggregated traffic to network 280 via PGW 230. In one example implementation, SGW 220 may route and forward user data packets, may act as a mobility anchor for a user plane during inter-eNB handovers, and may act as an anchor for mobility between LTE and other 3GPP technologies.

MME 225 may include one or more network devices that perform operations associated with a handoff to and/or from the EPS. MME 225 may perform operations to register user device 210 with the EPS, to handoff user device 210 from the EPS to another network, to handoff a user device 210 from the other network to the EPS, and/or to perform other operations. MME 225 may perform policing operations for traffic destined for and/or received from user device 210. MME 225 may authenticate user device 210 (e.g., via interaction with HSS/AAA server 235). In some implementations, MME 225 may receive policy information from load balancing server 245, and may communicate with base station 215 to establish bearers in accordance with the policy information.

PGW 230 may include one or more network devices, such as a gateway, a router, a modem, a switch, a firewall, a NIC, a hub, a bridge, a proxy server, an OADM, or some other type of device that processes and/or transfers traffic. PGW 230 may, for example, provide connectivity of user device 210 to external packet data networks by being a traffic exit/entry point for user device 210. PGW 230 may perform policy enforcement, packet filtering, charging support, lawful intercept, and/or packet screening. PGW 230 may also act as an anchor for mobility between 3GPP and non-3GPP technologies.

HSS/AAA server 235 may include one or more computing devices, such as a server device or a collection of server devices. In some implementations, HSS/AAA server 235 may include a device that gathers, processes, searches, stores, and/or provides information in a manner described herein. For example, HSS/AAA server 235 may manage, update, and/or store, in a memory associated with HSS/AAA server 235, profile information associated with user device 210 that identifies applications and/or services that are permitted for and/or accessible by user device 210, bandwidth or data rate thresholds associated with the applications or services, information associated with a user of user device 210 (e.g., a username, a password, a personal identification number (PIN), etc.), rate information, minutes allowed, and/or other information. Additionally, or alternatively, HSS/AAA server 235 may include a device that performs authentication, authorization, and/or accounting (AAA) operations associated with a communication connection with user device 210.

CSCF server 240 may include one or more computing devices, such as a server device or a collection of server devices. In some implementations, CSCF server 240 may include a device that gathers, processes, searches, stores, and/or provides information in a manner described herein. CSCF server 240 may process and/or route calls to and from user device 210 via the EPC. For example, CSCF server 240 may process calls, received from network 260, that are destined for user device 210. In another example, CSCF server 260 may process calls, received from user device 210, that are destined for network 260.

Load balancing server 245 may include one or more server devices that may mitigate network congestion based on information identifying types of traffic transmitted to and/or from user device 210, load information received from base stations 215 and/or access point 255, event information received from event information server 250, and/or some other information (e.g., information types of devices, such as smart phones, machine-to-machine (M2M) devices, etc.). For example, load balancing server 245 may direct base station 215 to transfer communications between user device 210 and base station 215 to another base station 215. Additionally, or alternatively, load balancing server 245 may direct user device 210 to communicate with access point 255 in lieu of base station 215 (e.g., to reduce load on a cellular network associated with base station 215). Additionally, or alternatively, load balancing server 245 may direct base station 215 to communicate with user device 210 via a different radio type or technology and/or via a different frequency band. Additionally, or alternatively, load balancing server 245 may implement network policies in order to mitigate network congestion. Load balancing server 245 may store information regarding access point 255. For example, load balancing server 245 may store location information and information identifying a communication range of access point 255.

Load balancing server 245 may provide network control regarding service data flow detection, termination points (e.g., access point name (APN)), (Quality of Service) QoS, and/or flow based charging. Policies and rules regarding QoS may include policies and rules instructing user device 210 and/or network devices (e.g., base station 215, SGW 220, MME 225, PGW 230, etc.) to minimize packet loss, to implement a packet delay budget, to provide a guaranteed bit rate (GBR), to provide a particular latency, and/or to perform other activities associated with QoS. Load balancing server 245 may provide policies and rules to other network devices, such as HSS/AAA server 235, and/or PGW 230, to implement network control. Load balancing server 245 may determine how a certain service data flow shall be treated, and may ensure that user plane traffic mapping and QoS is in accordance with a user's profile, a level of network congestion, and/or network policies. In some implementations, load balancing server 245 may perform network selection and traffic steering between different base stations 215 based on a Proxy Mobile IP v6 (PMIP) protocol, a Mobile IP (MIP) protocol, and/or based on some other technique.

Event information server 250 may include one or more computing devices, such as a server device or a collection of server devices. In some implementations, event information server 250 may store information identifying events. The information identifying events may be used by load balancing server 245 to anticipate instances of network congestion. For example, event information server 250 may store information identifying times and locations of sporting events, concert events, public events, a broadcasting event, and/or some other type of event in which network congestion may occur.

Access point 255 may include one or more network devices that may provide access to a public network independently of a cellular network associated with base station 215. For example, access point 255 may include an access point associated with a Wi-Fi based access network or another type of access network. Access point 255 may communicate with user device 210 when user device 210 is within a communications range of access point 255.

Network 260 may include one or more wired and/or wireless networks. For example, network 260 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, network 260 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in environment 200 is not limited to what is shown in FIG. 2. In practice, environment 200 may include additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

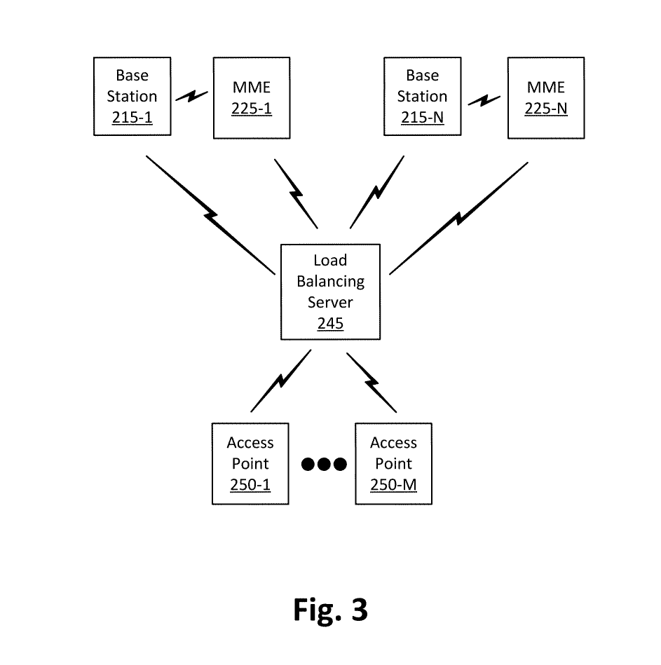

FIG. 3 illustrates a load balancing server communicating with multiple base stations, MMEs, and access points. In some implementations, load balancing server 245 may communicate with multiple base stations 215 associated with different geographic locations. For example, load balancing server 245 may communicate with the multiple base stations 215 to receive load information (e.g., to determine mitigation instructions based on the load information). Load balancing server 245 may also communicate with multiple MMEs 225 corresponding to the multiple base stations 215 (e.g., to output policies relating to mitigation of network congestion). Load balancing server 245 may also communicate with multiple access points 250 (e.g., to determine load information associated with the multiple access points).

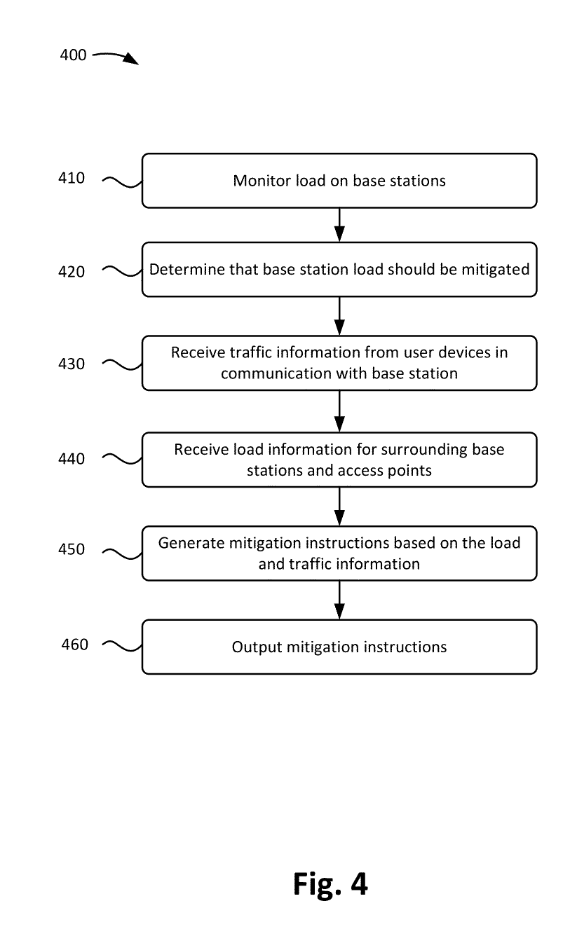

FIG. 4 illustrates a flowchart of an example process 400 for mitigating network congestion associated with a particular base station. In some implementations, process 400 may be performed by load balancing server 245. In some implementations, some or all of blocks of process 400 may be performed by one or more other devices.

As shown in FIG. 4, process 400 may include monitoring load on base stations (block 410). For example, load balancing server 245 may monitor load on base station 215, (e.g. a quantity of sessions established with base station 215, load and/or interference measurements associated with a frequency band and/or radio via which base station 215 communicates, load on a radio via which base station 215 communicates, etc.). Additionally, or alternatively, load balancing server 245 may monitor some other type of load information associated with base station 215. In some implementations, process 400 may monitor load on multiple base stations 215.

Process 400 may also include determining that the load on the base station should be mitigated (block 420). For example, load balancing server 245 may determine that the load on the base station 215 should be mitigated when a quantity of sessions established with base station 215 exceeds a particular threshold. Additionally, or alternatively, load balancing server 245 may determine that load on base station 215 should be mitigated when load and/or interference measurements of the frequency band and/or radio via which base station 215 communicates exceeds a particular threshold. Additionally, or alternatively, load balancing server 245 may determine that the load on base station 215 should be mitigated based on event information received from event information server 250 (e.g., when the event information indicates that a relatively large quantity of user devices 210 are expected to travel to a communications range of base station 215).

Additionally, or alternatively, load balancing server 245 may determine that load on base station 215 should be mitigated based on some other information that anticipates that load on base station 215 may exceed a threshold. For example, load balancing server 245 may anticipate that load on base station 215 may exceed the threshold based on location information of user devices 210 that indicate that a relatively large quantity of user devices 210 are traveling to within a communications range of base station 215. Additionally, or alternatively, load balancing server 245 may anticipate that load on base station 215 may exceed the threshold based on a rate of increase of the load.

Process 400 may further include receiving traffic information from user devices in communication with the base station (block 430). For example, load balancing server 245 may receive information identifying the types of traffic transmitted to and/or from user devices 210. Load balancing server 245 may determine whether a user device 210 may be offloaded from base station 215 to access point 255. For example, load balancing server 245 may identify user devices 210 that may need to communicate via a cellular network associated with base station 215 (or another base station 215). Load balancing server 245 may also identify user devices 210 that may not need to communicate via the cellular network and may communicate via access point 255. For example, load balancing server 245 may determine that user devices 210 currently in a telephone call may need to continue to communicate via the cellular network (e.g., via base station 215). Additionally, or alternatively, load balancing server 245 may determine that user devices 210 currently performing a task that requires the cellular network may need to communicate via the cellular network. Similarly, load balancing server 245 may identify user devices 210 that may not need to communicate via the cellular network and may instead communicate via access point 255 (e.g., user devices engaged in web browsing and/or other applications that do not require a communicate with the cellular network). As described in greater details below, load balancing server 245 may transfer communications between user device 210 and base station 215 to access point 255 (e.g., when user device 210 does not need to communicate via the cellular network).

Process 400 may also include receiving load information from other base stations and access points (block 440). For example, load balancing server 245 may receive load information from other base stations 215 and access points 255. In some implementations, load balancing server 245 may receive information identifying a quantity of sessions established with base stations 215 and/or access points 255. Additionally, or alternatively, load balancing server 245 may monitor load and/or interference measurements associated with a frequency band and/or radio via which base stations 215 and/or access points 255 communicate. In some implementations, load balancing server 245 may continuously maintain the load information as the load information changes in real-time.

Process 400 may further include generating mitigation instructions based on the load and traffic information (block 450). For example, load balancing server 245 may generate mitigation instructions based on the load information associated with base stations 215 and/or access point 255. Additionally, or alternatively, load balancing server 245 may generate the mitigation instructions based on the traffic information associated with user devices 210 in communication with base station 215. Additionally, or alternatively, load balancing server 245 may generate the mitigation instruction based on event information received from event information server 250.

As described above, load balancing server 245 may generate a mitigation instruction to transfer those user devices 210 that do not need to communicate via a cellular network from base station 215 to access point 255. For example, load balancing server 245 may generate a mitigation instruction to cause user device 210 to discontinue transmitting types of traffic via base station 215 (e.g., traffic that can be transmitted independently of a cellular network), and to instead transmit the traffic via a particular access point 255 that is within the communications range of user device 210 and that has the capacity to communicate with user device 210. In some implementations, the mitigation instruction may include a broadcast identifier (ID) of the particular access point 255 and authentication credentials that user device 210 may use to communicate with the particular access point 255. In some implementations, load balancing server 245 may select the particular access point 255, out of multiple access points 255, having the least amount of load. Additionally, or alternatively, load balancing server 245 may select the particular access point 255 that is closest to user device 210. Additionally, or alternatively, load balancing server 245 may select the particular access point 255 using some other technique.

As another example, load balancing server 245 may generate a mitigation instruction to transfer the communications between user device 210 and base station 215 to another base station 215 (e.g., a base station 215 having less load, or associated with a frequency band having less congestion). For example, the mitigation instruction may cause base station 215 to initiate a handoff process in order to transfer the communications to the other base station 215. Additionally, or alternatively, load balancing server 245 may generate a mitigation instruction to cause base station 215 to communicate with user device 210 via a different frequency band and/or via a different radio. For example, if interference information associated with a first frequency band indicates that the first frequency band is congested, load balancing server 245 may cause base station 215 to activate a second frequency band, and offload communications with a group of user devices 210 from the first frequency band to the second frequency band. Additionally, or alternatively, load balancing server 245 may cause base station 215 to handoff communications to another base station 215 associated with the second frequency band (e.g., a frequency band having less interference than the first frequency band).

Additionally, or alternatively, load balancing server 245 may generate a mitigation instruction to modify transmission policies for traffic transmitted to and/or from user device 210 (e.g., for user devices 210 that may continue to need to communicate with the cellular network via base station 215). For example, load balancing server 245 may generate a mitigation instruction to modify a QoS policy in order to reduce the amount of bandwidth consumed when transferring traffic to and/or from user device 210 (e.g., a policy to lower the resolution of video traffic, lower the bitrate of audio traffic, convert a video call into a voice-only call, etc.). In some implementations (e.g., when the type of traffic transmitted to/from user device 210 includes voice call data), load balancing server 245 may generate a mitigation instruction to modify the bitrate of voice call audio traffic from a fixed bitrate to a dynamic bitrate. Further, the mitigation instruction may direct base station 215 to lower the bitrate of the transmission of the audio traffic after modifying the bitrate from a fixed bitrate to a dynamic bitrate.

In some implementations, load balancing server 245 may determine policies for a group of user devices 210 and/or for individual user devices 210. In some implementations, load balancing server 245 may determine policies based on a subscription level associated with base station 215, an amount of load on base station 215, an amount of interference for a frequency band via which user device 210 and base station 215 communicate, an amount of anticipated load, and/or an amount of anticipated frequency band interference.

Process 400 may further include outputting the mitigation instruction (block 460). For example, load balancing server 245 may output the mitigation instruction to base station 215. Based on receiving the mitigation instruction, base station 215 may communicate with user device 210 to execute the mitigation instruction. For example, if the mitigation instruction includes a broadcast ID of access point 255 and authentication credentials for communicating with access point 255, base station 215 may output the broadcast ID and the authentication credentials to user device 210 (e.g., via a radio resource control (RRC) signal and/or via some other signal). Based on receiving the RRC signal, user device 210 may execute an RRC connection reconfiguration process to discontinue transmitting types of traffic via base station 215 (e.g., traffic that can be transmitted independently of a cellular network) a and to instead transmit the traffic via access point 255. For example, user device 210 may communicate with access point 255 using the authentication credentials included in the RRC signal.

As another example, if the mitigation instruction directs base station 215 to discontinue communications with user device 210 via a first frequency band, and instead communicate with base station 215 via a second frequency band, base station 215 may communicate with user device 210 via a radio associated with the second frequency band. Additionally, or alternatively, base station 215 may execute a software process to communicate with user device 210 via the second frequency band. As another example, base station 215 may initiate a handoff process to handoff user device 210 to another base station 215.

As another example, if the mitigation instruction includes a modification to transmission policies, load balancing server 245 may output information regarding the modified policies to MME 225. Based on receiving the information regarding the modified policies, MME 225 may generate a bearer re-establishment instruction, and output the instruction to base station 215 to cause base station 215 to re-establish a bearer with user device 210 in accordance with the modified policies.

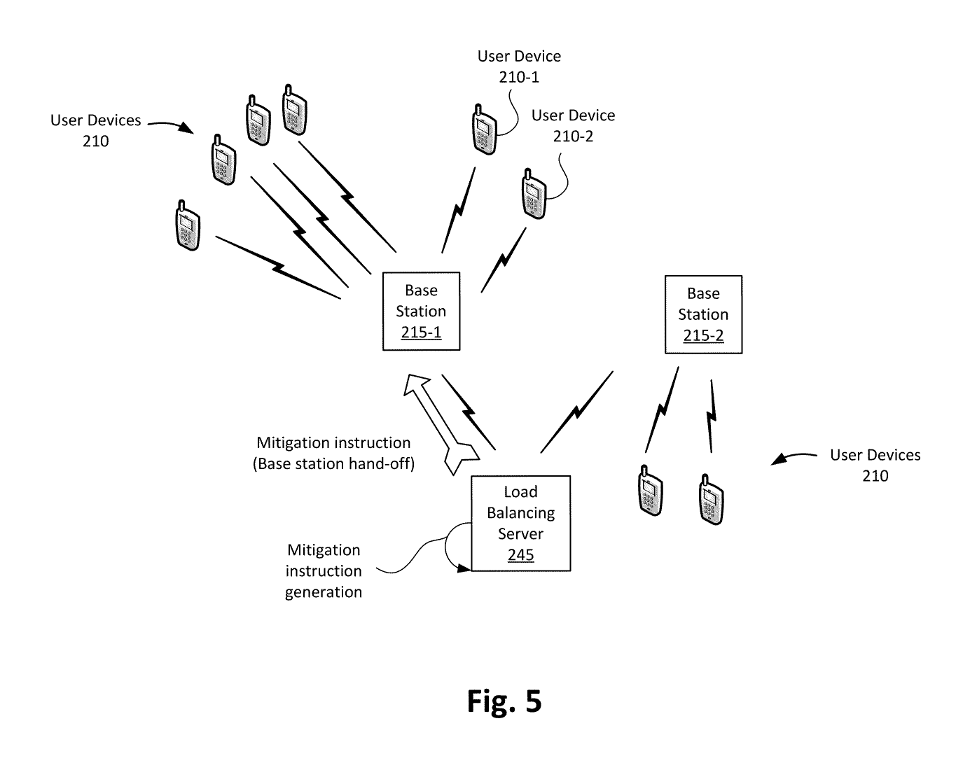

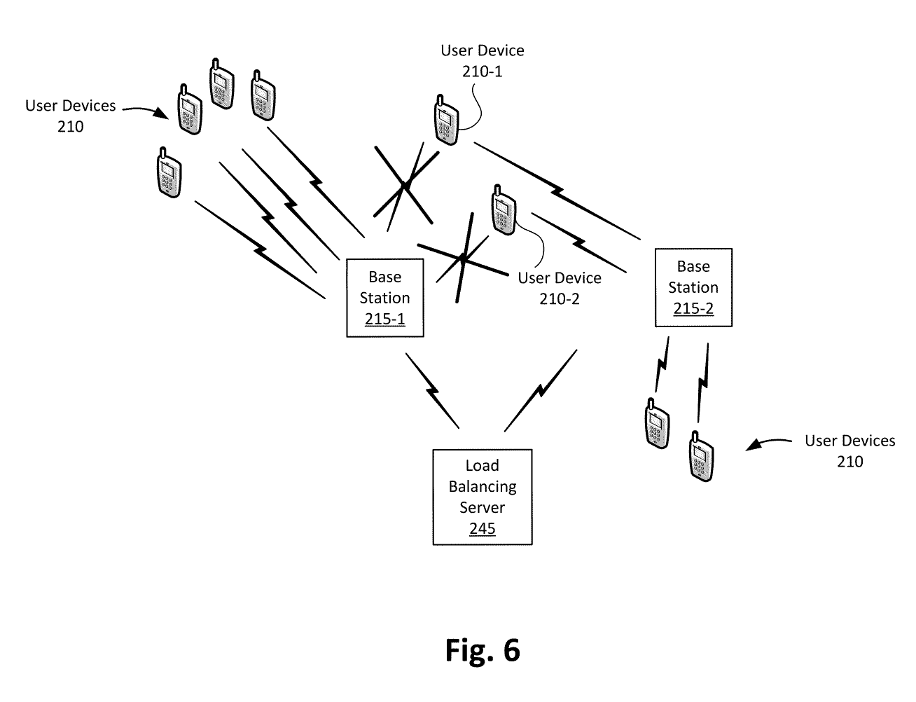

FIGS. 5-6 illustrate an example implementation for proactively handing off user devices from a first base station to a second base station. As shown in FIG. 5, user devices 210 may communicate with a first base station (e.g., base station 215-1). User devices 210-1 and 210-2 may communicate with a second base station (e.g., base station 215-2). Load balancing server 245 may determine that load on base station 215-1 should be mitigated (e.g., if the quantity of sessions has exceed a particular threshold, if load on base station 215-1 has exceeded a particular threshold, and/or if interference of a frequency band via which base station 215-1 communicates has exceeded a threshold). Load balancing server 245 may also determine that user device 210-1 and user device 210-2 are also located within a communications range of base station 215-2, and that base station 215-2 has the capacity to communicate with user device 210-1 and user device 210-2. Load balancing server 245 may generate a mitigation instruction to direct base station 215-1 to handoff user device 210-1 and user device 210-2 to base station 215-2. Load balancing server 245 may also output the mitigation instruction to base station 215-1

Referring to FIG. 6, base station 215-1 may handoff user device 210-1 and user device 210-2 to base station 215-2. As such, user device 210-1 and user device 210-2 may discontinue communicating with base station 215-1, and may instead communicate with base station 215-2. As a result, load on base station 215-1 may be reduced to levels below a particular threshold in which base station 215-1 is considered to be overloaded. Further, the load may be proactively reduced by load balancing server 245. As such, users of user device 210-1 and user device 210-2 may experience fewer symptoms of network congestion (e.g., increased latency, increased jitter, reduced bitrates, reduced audio/video quality, etc.) than if the load was not proactively reduced. That is, user device 210-1 and user device 210-2 may be proactively handed off to base station 215-2 before experiencing network congestion.

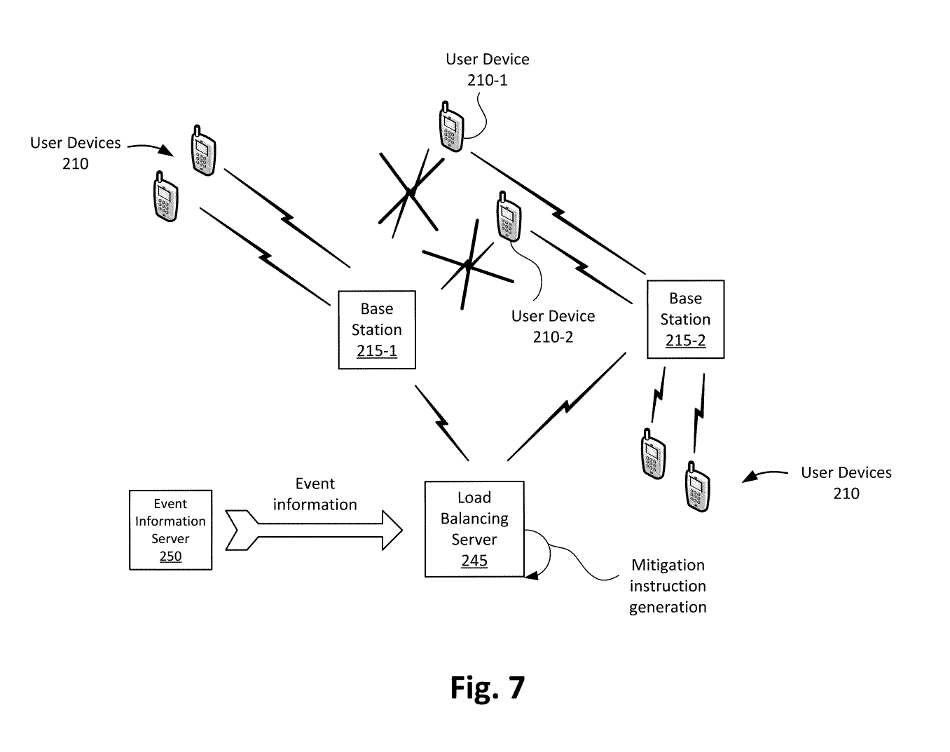

FIG. 7 illustrates an example implementation for proactively mitigating load on a base station based on event information. As shown in FIG. 7, load balancing server 245 may receive event information from event information server 250 (e.g., information identifying an event and/or some other information indicating that base station 215-1 may become overloaded). Based on receiving the event information, load balancing server 245 may generate a mitigation instruction to cause base station 215-1 to handoff user device 210-1 and user device 210-2 to base station 215-2. User device 210-1 and user device 210-2 may then communicate with base station 215-2 instead of base station 215-1. As a result, load on base station 215-1 may be proactively mitigated in order to reduce load on base station 215-1 when load on base station 215-1 is anticipated to increase based on event information.

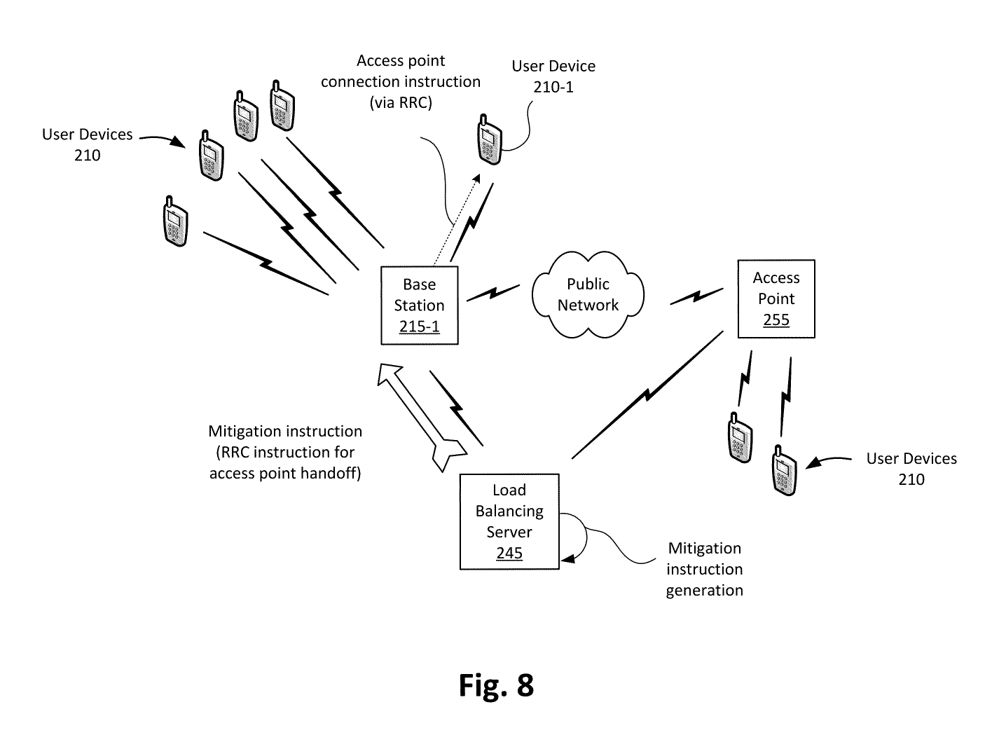

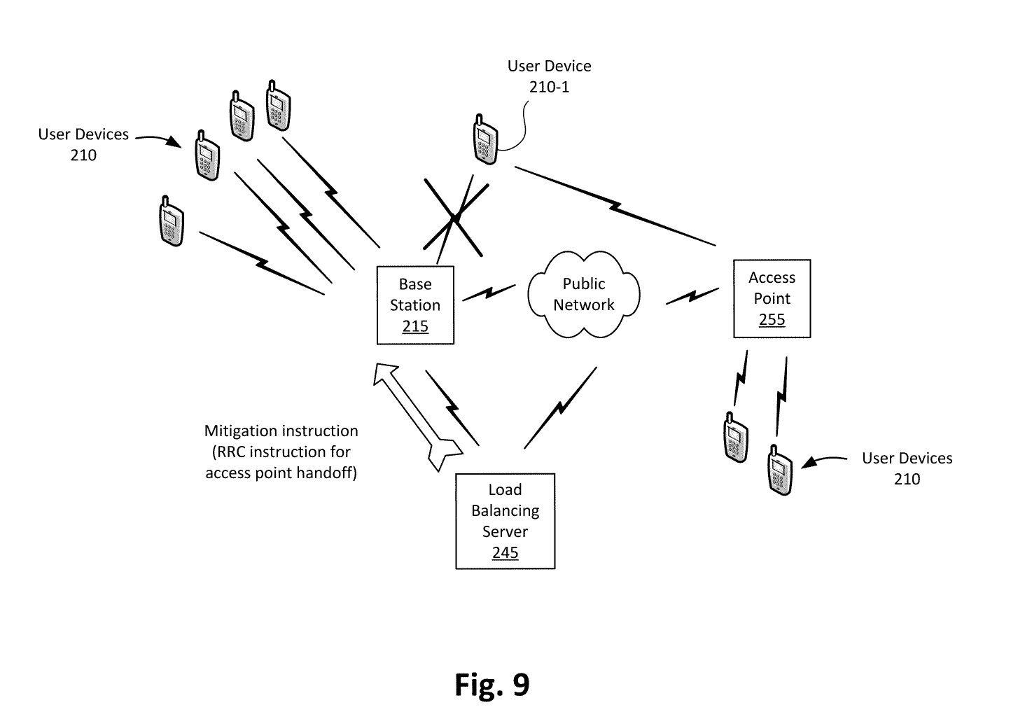

FIGS. 8 and 9 illustrate an example implementation for proactively mitigating load on a base station by transferring communications to an access point. As shown in FIG. 8, load balancing server 245 may determine that load on base station 215 should be mitigated, and may also determine that communications of user device 210-1 may be transferred from base station 215 to access point 255. For example, load balancing server 245 may determine that the load should be mitigated when user device 210-1 is in communications range of access point 255 and when user device 210-1 does not require a connection a cellular network accessible via base station 215 (e.g., when user device 210-1 is transmitting and/or receiving data to and/or from a public network that may be accessed via access point 255).

Load balancing server 245 may generate a mitigation instruction to cause user device 210-1 to communicate with access point 255 instead of base station 215. For example, load balancing server 245 may include, in the mitigation instruction, an ID of access point 255 (e.g., a service set ID (SSID)) and authentication credentials for access point 255. Base station 215 may receive the mitigation instruction, and may output the SSID of access point 255 and the authentication credentials to user device 210-1. For example, base station 215 may output the SSID and the authentication credentials via an RRC signal which user device 210-1 may receive via a control plane. Based on receiving the RRC signal, user device 210-1 may execute a connection re-establishment process to communicate with access point 255 and discontinue transmitting types of traffic via base station 215. For example, user device 210-1 may identify access point 255 based on the SSID, and may communicate with access point 255 using the authentication credentials.

Referring to FIG. 9, user device 210-1 may discontinue transmitting types of traffic via base station 215 (e.g., after connecting with access point 255). As a result, the load on base station 215 may be reduced, and user device 210-1 may continue to access the public network. In some implementations, symptoms of network congestion may be averted as a result of proactivity transferring communications between base station 215 and user device 210-1 to access point 255.

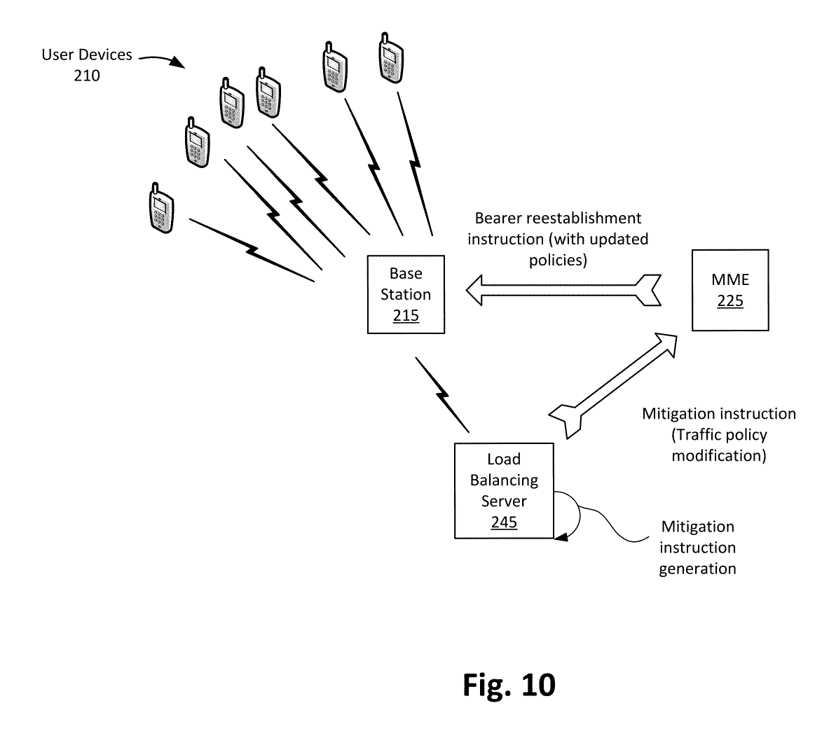

FIG. 10 illustrates an example implementation for proactively mitigating load on a base station by modifying network transmission policies. As shown in FIG. 10, load balancing server 245 may determine that load on a base station 215 should be mitigated. For example, load balancing server 245 may determine that the load should be mitigated when an amount of network load exceeds a threshold, when a rate of increase of load exceeds a threshold, and/or when event information received from event information server 250 indicates that load on base station 215 may exceed the threshold. Additionally, or alternatively, load balancing server 245 may determine that the load should be mitigated based on some other technique.

Load balancing server 245 may generate a mitigation instruction that identifies a modification in network transmission policies (e.g., a modification that may reduce the load on base station 215). For example, load balancing server 245 may generate a mitigation instruction having policies to reduce a resolution of video data transmitted to and/or from user devices 210. Additionally, or alternatively, load balancing server 245 may generate a mitigation instruction having policies to reduce an audio bitrate of audio data transmitted to and/or from user device 210. Additionally, or alternatively, load balancing server 245 may generate a mitigation instruction having policies relating to packet queuing techniques that may increase transmission latency for particular types of traffic in favor of reducing latency for other types of traffic. For example, traffic for which transmission latency may be acceptable (e.g., traffic relating to the delivery of text documents) may be queued after traffic for which latency may be less acceptable (e.g., traffic relating to voice or video calls). That is, transmission latency for the traffic relating to text documents may be increased in favor of reducing traffic relating to voice or video calls. Additionally, or alternatively, load balancing server 245 may generate a mitigation instruction having some other policy in order to reduce the load on base station 215.

As further shown in FIG. 10 load balancing server 245 may output the mitigation instruction (i.e., the modification in network transmission policies) to MME 225. Based on receiving the mitigation instruction, MME 225 may communicate with base station 215 to reestablish bearers in accordance with the modified policies.

While particular examples are shown in FIGS. 5-10, it will be apparent that the above description are merely example implementations. Other examples are possible and may differ from what was described with regard to FIGS. 5-10.

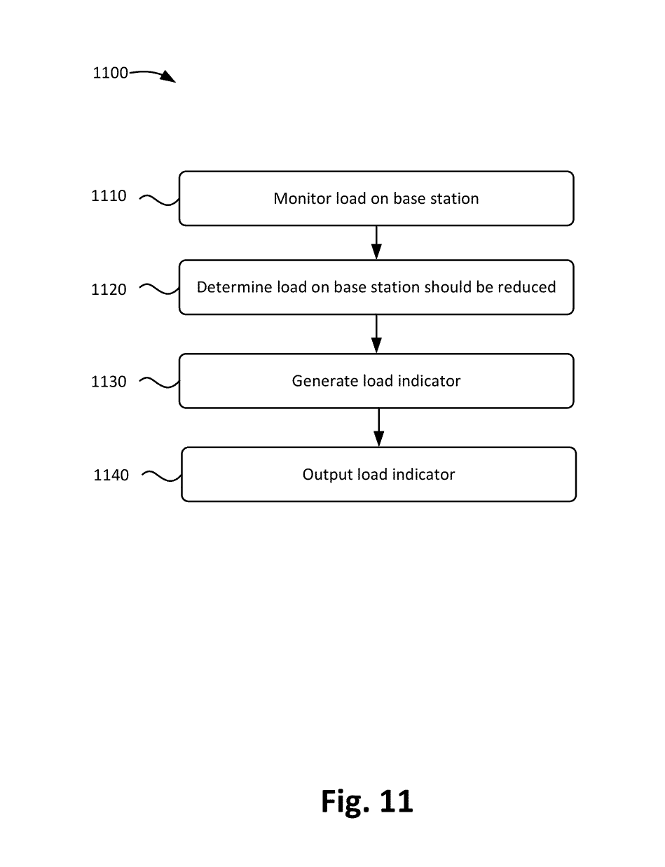

FIG. 11 is a flow chart of an example process 1100 for generating and outputting a load indicator. In some implementations, process 1100 may be performed by load balancing server 245. In some implementations, some or all of blocks of process 1100 may be performed by one or more other devices.

As shown in FIG. 11, process 1100 may include monitoring load on a base station (block 1110). For example, load balancing server 245 may monitor load on a resource block associated with base station 215 (e.g. a quantity of sessions established with base station 215, load and/or interference measurements associated with a frequency band and/or radio via which base station 215 communicates, load on a radio via which base station 215 communicates, etc.). Additionally, or alternatively, load balancing server 245 may monitor some other type of load information associated with base station 215.

Process 1100 may also include determining that load on a base station should be reduced (block 1120). For example, load balancing server 245 may determine that the load on base station 215 should be reduced when a quantity of sessions established with base station 215 exceeds a particular threshold. Additionally, or alternatively, load balancing server 245 may determine that load on base station 215 should be reduced when load and/or interference measurements of the frequency band and/or radio via which base station 215 communicates exceeds a particular threshold. Additionally, or alternatively, load balancing server 245 may determine that the load on base station 215 should be reduced based on event information received from event information server 250 (e.g., when the event information indicates that a relatively large quantity of user devices 210 are expected to travel to a communications range of base station 215).

Additionally, or alternatively, load balancing server 245 may determine that load on base station 215 should be reduced based on some other information that anticipates that load on base station 215 may exceed a threshold. For example, load balancing server 245 may anticipate that load on base station 215 may exceed the threshold based on location information of user devices 210 that indicate that a relatively large quantity of user devices 210 are traveling to within a communications range of base station 215. Additionally, or alternatively, load balancing server 245 may anticipate that load on base station 215 may exceed the threshold based on a rate of increase of the load. Additionally, or alternatively, load balancing server 245 may determine that load on base station 215 should be reduced based on types of devices in communication with base station 215. For example, different types of devices (e.g., smartphones, laptops, M2M devices, etc.) may consume different levels of bandwidth.

Process 1100 may further include generating a load indicator (block 1130). For example, load balancing server 245 may generate the load indicator based on determining that the load on base station 215 should be reduced. In some implementations, the load indicator may indicate that base station 215 is overloaded, and user device 210 should attempt to discontinue communicating via base station 215, and to instead communicate via a different base station 215, and/or via access point 255. In some implementations, the load indicator may indicate that user device 210 should attempt to discontinue communicating via a particular resource block of base station 215 (e.g., a particular radio associated with a particular frequency), and instead communicate via a different resource block of base station 215.

Process 1100 may also include outputting the load indicator (block 1140). For example, load balancing server 245 may output the load indicator as a broadcast message that user devices 210 may receive when within communications range of a base station 215 associated with the load indicator.

Based on receiving the load indicator, user device 210 may attempt to discontinue communicating via base station 215 (e.g., base station 215-1), and instead communicate via a different base station 215 (e.g., 215-2) and/or via access point 255. For example, if user device 210 is currently transmitting traffic that does not require a connection with base station 215-1, and if user device 210 is within a communication range of access point 255, user device 210 may discontinue communicating with base station 215-1 and instead communicate with access point 255. If user device 210 is not within communications range of access point 255, but is within communications range of base station 215-2, user device 210 may discontinue communicating via base station 215-1 and may instead communicate via base station 215-2. If user device 210 is not within communications range of access point 255 or any other base station 215, user device 210 may continue to communicate via base station 215-1, but may reduce the amount of bandwidth consumed by user device 210 (e.g., by reducing the resolution of video traffic, reducing the bitrate of audio traffic, convert a video call into a voice-only call, etc.). Additionally, or alternatively, user device 210 may discontinue communicating via a first radio of base station 215-1 and may instead communicate via a second radio of base station 215-1.

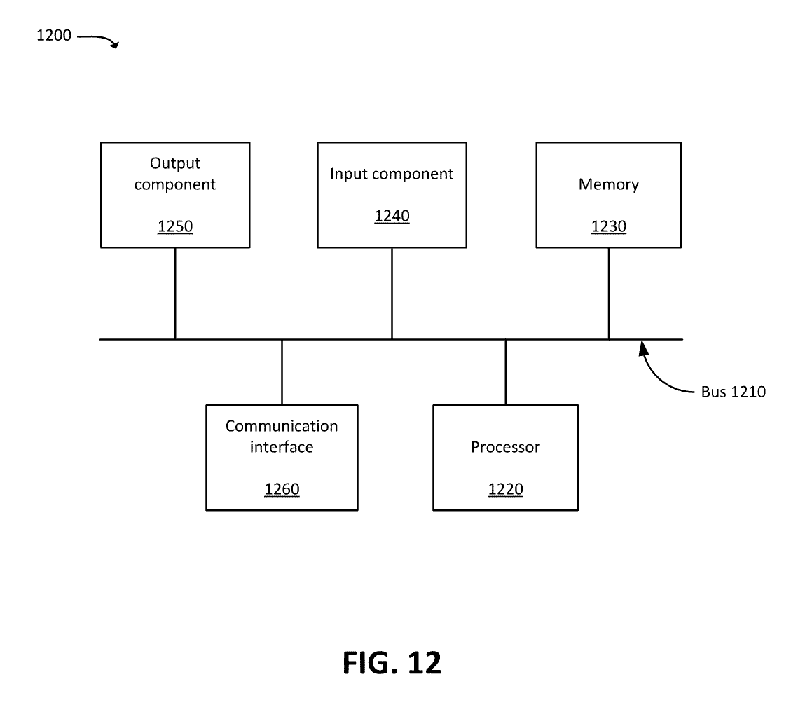

FIG. 12 is a diagram of example components of device 1200. One or more of the devices described above (e.g., with respect to FIGS. 1-3, and 5-10) may include one or more devices 1200. Device 1200 may include bus 1210, processor 1220, memory 1230, input component 1240, output component 1250, and communication interface 1260. In another implementation, device 1200 may include additional, fewer, different, or differently arranged components.

Bus 1210 may include one or more communication paths that permit communication among the components of device 1200. Processor 1220 may include a processor, microprocessor, or processing logic that may interpret and execute instructions. Memory 1230 may include any type of dynamic storage device that may store information and instructions for execution by processor 1220, and/or any type of non-volatile storage device that may store information for use by processor 1220.

Input component 1240 may include a mechanism that permits an operator to input information to device 1200, such as a keyboard, a keypad, a button, a switch, etc. Output component 1250 may include a mechanism that outputs information to the operator, such as a display, a speaker, one or more light emitting diodes (“LEDs”), etc.

Communication interface 1260 may include any transceiver-like mechanism that enables device 1200 to communicate with other devices and/or systems. For example, communication interface 1260 may include an Ethernet interface, an optical interface, a coaxial interface, or the like. Communication interface 1260 may include a wireless communication device, such as an infrared (“IR”) receiver, a Bluetooth® radio (Bluetooth is a registered trademark of Bluetooth SIG, Inc.), radio, or the like. The wireless communication device may be coupled to an external device, such as a remote control, a wireless keyboard, a mobile telephone, etc. In some embodiments, device 1200 may include more than one communication interface 1260. For instance, device 1200 may include an optical interface and an Ethernet interface.

Device 1200 may perform certain operations relating to one or more processes described above. Device 1200 may perform these operations in response to processor 1220 executing software instructions stored in a computer-readable medium, such as memory 1230. A computer-readable medium may be defined as a non-transitory memory device. A memory device may include space within a single physical memory device or spread across multiple physical memory devices. The software instructions may be read into memory 1230 from another computer-readable medium or from another device. The software instructions stored in memory 1230 may cause processor 1220 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while a series of blocks have been described with regard to FIGS. 4 and 11, the order of the blocks may be modified in other implementations. Further, non-dependent blocks may be performed in parallel.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown (e.g., in FIGS. 1-3, and 5-10), in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold” “being less than a threshold” “being less than or equal to a threshold,” or other similar terms, depending on the context in which the threshold is used.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method comprising:
monitoring, by a device, load information associated with a base station in communication with a user device via a wireless cellular network;
determining, by the device and based on the load information, that load on the base station should be reduced;
determining, by the device, in response to the determination that the load on the base station should be reduced, and based on a type of traffic being transmitted to the user device via the base station, whether traffic for the user device can be offloaded to an access point within communications range of the user device; and
causing, by the device and based on determining that the traffic for the user device can be offloaded to the access point, the user device to communicate via the access point and discontinue transmitting the traffic via the base station.

2. The method of claim 1, wherein the base station is a first base station,
the method further comprising:
receiving, based on determining that the traffic for the user device cannot be offloaded to the access point, information identifying load associated with a second base station that is within communications range of the user device,
determining a rate of increase of the load;
determining, based on the rate of increase of the load, that the second base station has capacity to communicate with the user device; and
causing, based on determining that the second base station has capacity to communicate with the user device, the user device to communicate via the second base station and discontinue communicating via the first base station.

3. The method of claim 1, wherein the base station is a first base station,
the method further comprising:
receiving, based on determining that the traffic for the user device cannot be offloaded to the access point, information identifying load associated with a second base station within communications range of the user device;
determining a rate of increase of the load;
determining, based on the rate of increase of the load, that the second base station does not have capacity to communicate with the user device; and
causing, based on determining that the second base station does not have capacity to communicate with the user device, a reduction of an amount of bandwidth used by the type of traffic transmitted to the user device.

4. The method of claim 1, further comprising:
causing, based on determining that the traffic for the user device cannot be offloaded to the access point, a reduction in an amount of bandwidth used by the type of traffic transmitted to the user device.

5. The method of claim 4, wherein the causing includes:
generating or updating a Quality of Service (QoS) policy, and
outputting the QoS policy to a mobility and management entity (MME) device to cause the base station to establish a bearer with the user device in accordance with the QoS policy.

6. The method of claim 1, wherein determining that the load on the base station should be reduced is based on receiving event information indicating an occurrence of an event that is likely to lead to overloading of the base station; and
determining, based on the event information, that the load on the base station should be reduced.

7. The method of claim 1, wherein determining that the traffic for the user device can be offloaded to the access point includes determining that the type of traffic being transmitted to the user device is not associated with a cellular network associated with the base station.

8. The method of claim 1, wherein the load information relates to a quantity of sessions established with the base station or a measure of load associated with a frequency band via which the base station communicates.

9. A system comprising:
a device, comprising:
a non-transitory memory device storing:
a plurality of processor-executable instructions; and
a processor configured to execute the processor-executable instructions, wherein executing the processor-executable instructions causes the processor to:
monitor load information associated with a base station in communication with a user device via a wireless cellular network;
determine, based on the load information, that load on the base station should be reduced;
determine, in response to the determination that the load on the base station should be reduced, and based on a type of traffic being transmitted to the user device via the base station, whether traffic for the user device can be offloaded to an access point within communications range of the user device; and
cause, based on determining that the traffic for the user device can be offloaded to the access point, the user device to communicate via the access point and discontinue transmitting the traffic via the base station.

10. The system of claim 9, wherein the base station is a first base station,
wherein executing the processor-executable instructions further causes the processor to:
receive, based on determining that the traffic for the user device cannot be offloaded to the access point, information identifying load associated with a second base station that is within communications range of the user device,
determine a rate of increase of the load;
determine, based on the rate of increase of the load, that the second base station has capacity to communicate with the user device; and
cause, based on determining that the second base station has capacity to communicate with the user device, the user device to communicate via the second base station and discontinue communicating via the first base station.

11. The system of claim 9, wherein the base station is a first base station,
wherein executing the processor-executable instructions further causes the processor to:
receive, based on determining that the traffic for the user device cannot be offloaded to the access point, information identifying load associated with a second base station within communications range of the user device;
determine a rate of increase of the load;
determine, based on the rate of increase of the load, that the second base station does not have capacity to communicate with the user device; and
cause, based on determining that the second base station does not have capacity to communicate with the user device, a reduction of an amount of bandwidth used by the type of traffic transmitted to the user device.

12. The system of claim 9, wherein executing the processor-executable instructions further causes the processor to:
cause, based on determining that the traffic for the user device cannot be offloaded to the access point, a reduction in an amount of bandwidth used by the type of traffic transmitted to the user device.

13. The system of claim 12, wherein executing the processor-executable instructions, to cause the base station to reduce an amount of bandwidth consumed, further causes the processor to:
generate or update a Quality of Service (QoS) policy, and
output the QoS policy to a mobility and management entity (MME) device to cause the base station to establish a bearer with the user device in accordance with the QoS policy.

14. The system of claim 9, executing the processor-executable instructions, to determine that the load on the base station should be reduced, causes the processor to:
determine that the load on the base station should be reduced based on receiving event information indicating an occurrence of an event that is likely to lead to overloading of the base station; and
determining, based on the event information, that the load on the base station should be reduced.

15. The system of claim 9, executing the processor-executable instructions, to determine that the traffic for the user device can be offloaded to the access point, causes the processor to determine that the type of traffic being transmitted to the user device is not associated with a cellular network associated with the base station.

16. The system of claim 9, wherein the load information relates to a quantity of sessions established with the base station or a measure of load associated with a frequency band via which the base station communicates.

17. A method comprising:
monitoring, by a base station, load information associated with the base station in communication with a user device;
determining, by the base station, that load on the base station should be reduced based on the monitored load information;
determining, by the base station, in response to the determination that the load on the base station should be reduced, and based on a type of traffic being transmitted to the user device via the base station, whether to offload a traffic flow to a Wi-Fi access network within communications range of the user device;
reducing, by the device and based on determining that the traffic flow cannot be offloaded to the Wi-Fi access network, an amount of bandwidth consumed by the traffic flow.

18. The method of claim 17, wherein reducing the amount of bandwidth further includes:
determining whether the traffic flow is a type of traffic flow that carries voice data;
changing, when it is determined that the traffic flow is a type of traffic flow that carries voice data, the traffic flow from a fixed bandwidth flow to a dynamic bandwidth flow; and
reducing the bandwidth, for the dynamic bandwidth flow, to accommodate the load on the base station.

19. The method of claim 17, wherein reducing the amount of bandwidth further includes:
generating or updating a Quality of Service (QoS) policy, and
establishing a bearer with the user device in accordance with the QoS policy.

20. The method of claim 17, further comprising:
causing, based on determining that the user device can be offloaded to the Wi-Fi access network, the user device to transmit the traffic flow traffic via the Wi-Fi access network and discontinue transmitting the traffic flow via the base station.
